(19) United States
(12) Patent Application Publication
(10) Pub. No.: US 2012/0007358 A1
(43) Pub. Date: Jan. 12, 2012

(54) Gasket Retention System for Flange Coupling

(75) Inventors: Lucas C. Mackey, Houston, TX (US); Michael R. Stapleton, Brenham, TX (US); Waverly L. Johnson, III, Houston, TX (US)

(73) Assignee: FEDERAL FLANGE, INC., Houston, TX (US)

(21) Appl. No.: 12/831,807

(22) Filed: Jul. 7, 2010

(51) Int. Cl. F16L 17/06; F16L 23/00

(52) U.S. Cl. 285/379; 285/363

(57) ABSTRACT

A gasket retention system and flange coupling has a ring gasket that disposes in seal seats on opposing flanges. One or more retainer tabs extend from an outer periphery of the ring gasket. Preferably, the ring gasket defines a slot on the outer periphery, and the retainer tab affixes with an interference fit in the slot to be held therein. The retainer tab defines a transverse opening therethrough. When the ring gasket fits into the seal seat of one of the flanges, the transverse opening of the tab fits onto a fastener affixed in a pre-drilled hole in the face of the flange.

### BACKGROUND

Pipelines carry oil, gas and other fluid hydrocarbons in industrial applications. The pipelines typically have pipe sections connected end-to-end to form a single conduit. Flange couplings on the ends of the pipe sections bolt or attach together to connect the pipe sections together. Because the pipeline can carry high-pressure or dangerous fluids, the couplings between the pipe sections must form tight seals. For this reason, pipe couplings normally use a gasket or other type of seal ring between the flanges to provide a tight seal.

An industry standard (ANSI, API, MSS, etc.) coupling between flanges and ring gasket can connect fluid transport pipelines that can be tens of inches in diameter. The ring gasket used in the coupling is designed to withstand high pressures and is often constructed of metal. Due to their size, the pipelines can be very heavy and unwieldy. This makes assembling the flange coupling difficult in the field and especially in harsh conditions. For example, operators may install such pipelines in subsea environments where visibility is severely limited, movement may be difficult, and dropped or mishandled equipment can be completely lost.

During assembly, operators try to seat the ring gasket properly between the flanges. To do this, the ring gasket disposes in a groove or seal seat in one flange. Typically, the ring gasket is not held in position so that it can be poorly seated or may move out of its seated position inadvertently during assembly. If the coupling is assembled with the ring gasket out of position, the ring gasket may be damaged and may not provide a good seal. If the flanges are facing vertically, seating the ring gasket in the seats can be particularly difficult.

FIGS. 1A-1B show a prior art solution as disclosed in U.S. Pat. Nos. 6,454,316 and 6,543,120 for holding a ring gasket 16 between flanges 12/14 of a coupling 10. Rather than having a male flange and a female flange, the coupling 10 uses two symmetrical flanges 12/14. Each has a groove 13/15 forming a seat for the ring gasket 16. Cams 20 attach to one flange 14 around the periphery of the ring gasket 16. When the cam 20 is closed as shown, its lip fits within a groove cut into the ring gasket 16 to hold the ring gasket 16 in position against flange 14. An attachment screw 22 secures the cam 20 to the flange 14.

Although the prior art solution may be effective, operators mating flanges together are interested in making assembly even easier. This is especially true when flanges are mated underwater. In an underwater environment or even in other industrial situations, requiring operators to perform fewer assembly steps can be important. Moreover, reducing the chances that components are misaligned or become loose can also be very helpful.

The subject matter of the present disclosure is directed to overcoming, or at least reducing the effects of, one or more of the problems set forth above.

### SUMMARY

A gasket retention system and flange coupling has a ring gasket that disposes in seal seats on opposing flanges. One or more retainer tabs extend from an outer periphery of the ring gasket. Preferably, the ring gasket defines a slot on the outer periphery, and the retainer tab affixes with an interference fit in the slot to be held therein. Accordingly, there is no need to define an extensive groove around the periphery of the ring gasket, which can be complicated and possibly detrimental to its integrity. The retainer tab defines a transverse opening therethrough. When the ring gasket fits into the seal seat of one of the flanges, the transverse opening of the tab fits onto a fastener affixed in the face of the flange.

The fastener can fit into a hole drilled in the flange's face outside the seal seat. Preferably, the fastener fits with an interference fit in the flange's hole and the tab's opening. Moreover, the tab's opening is preferably elongated to allow for relative adjustment between the tab and the pin when operators seat the ring gasket in the flange's seat. The retainer tab can be composed of metal, plastic, polymer, composite, or other material, and the fastener can be a screw, a bolt, a pin, a rivet, a plug, or the like of any suitable material. Both flanges or just the opposing flange can have a cutaway in a periphery of its face to accommodate portion of the fastener.

In preparation of coupling the flanges, holes are pre-drilled in the face of one of the flanges outside the ring gasket. Fasteners are installed in the pre-drilled holes, and the retainer tabs are affixed in slots in the ring gasket. During installation in the field, operators install the ring gasket in the seal seat of the flange while fitting the retainer tabs onto the fasteners. In this way, the fasteners and retainer tabs hold the ring gasket in place in the flange's seal seat while operators continue assembly procedures, and operators need only place and fit the ring gasket on the flange. There is no particular need for the operations to make adjustments, move parts, or modify components during assembly of the coupling other than placing and fitting the tabs on the fasteners. Finally, operators mate another flange to the prepared flange so the ring gasket fits between the mated flanges.

The foregoing summary is not intended to summarize each potential embodiment or every aspect of the present disclosure.

### BRIEF DESCRIPTION OF THE DRAWINGS

FIG. 1A is a cross-sectional view of a coupling between flanges having rotatable cams to hold a ring gasket according to the prior art.

FIG. 1B is a top view of one of the flanges having the cam to hold the ring gasket according to the prior art.

FIG. 2 is a perspective view of a ring gasket having retainer tabs according to the present disclosure.

FIG. 3 is a perspective view of a prepared flange having a seal seat, predrilled placement holes, and fasteners according to the present disclosure.

FIG. 4 is a perspective view of a retainer tab.

FIGS. 5A-5C show views of a retainer tab inserting into a slot in the ring gasket.

FIG. 6 shows the face of a prepared flange having placement pins, retainer tabs, and ring gasket installed.

FIGS. 7A-7C shows various arrangements of ring gaskets and retainer tabs for the disclosed coupling.

FIG. 8 is a side view of a coupling between flanges according to the present disclosure.

FIGS. 9A-9B show cross-sectional views of the coupling between flanges.

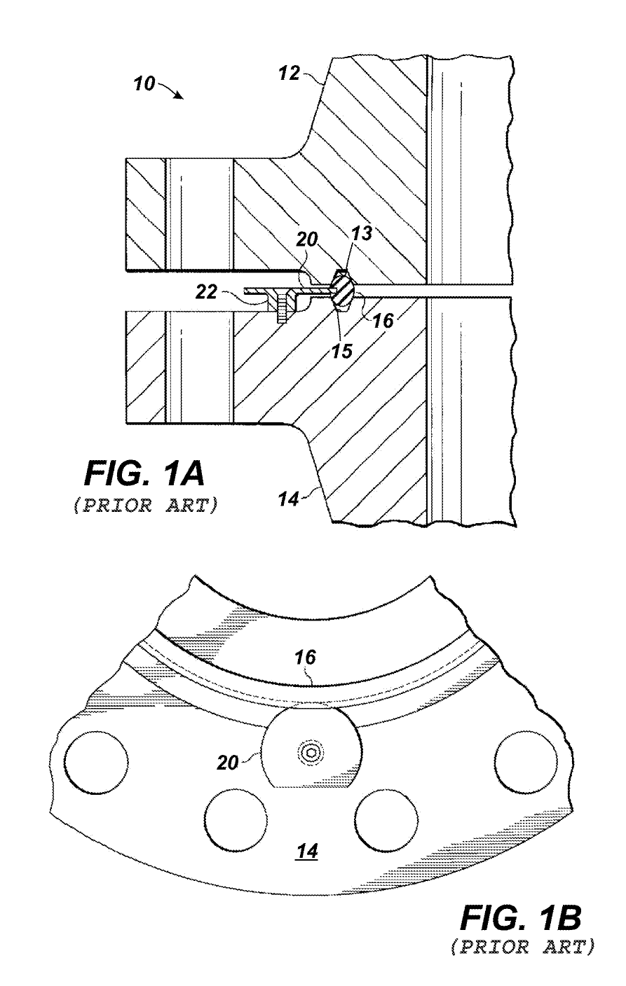

### DETAILED DESCRIPTION

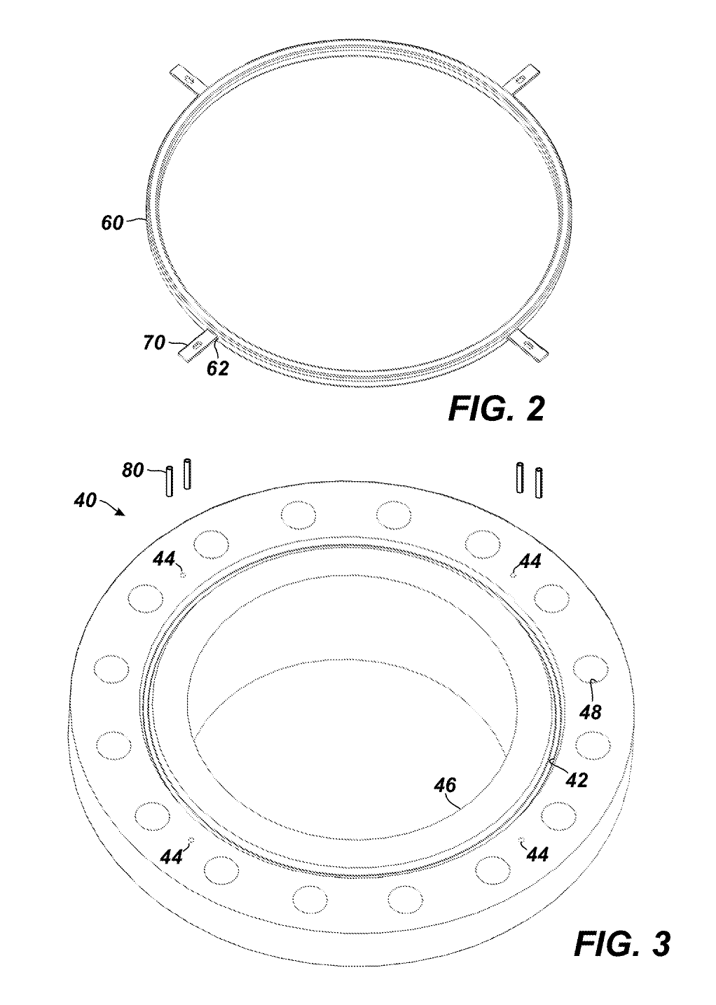

As shown in FIGS. 2 through 9B, a coupling 50 according to the present disclosure is made between flanges 30/40 using a ring gasket 60, retainer tabs 70, and placement fasteners or pins 80. As best shown in FIGS. 9A-9B, the ring gasket 60 fits in seal seats 32/42 in opposing faces of the flanges 30/40. To facilitate the ring gasket's placement and to hold it in place during assembly, the ring gasket 60 has several retainer tabs 70 that extend from the periphery of the ring gasket 60. The retainer tabs 70 have openings 72 that fit onto placement pins 80 extending from the face of one of the flanges 40.

As shown in FIG. 2A, the ring gasket 60 can have four retainer tabs 70, although more or less could be used. The ring gasket 60 can be an industry standard ring joint (RTJ) gasket that has been altered with slots 62 to accommodate the retainer tabs 70. In general, the ring gasket 60 can be any of the standard type of gasket, being oval, octagonal, or the like and can include, but is not limited to, the R-type from ASME B16.20 and API 6A, the RX-type and BX-type from API 6A, or the SRX-type and SBX-type from API 17D. Typically, the ring gasket 60 is composed of a suitable metal.

To prepare the ring gasket 60 to receive the retainer tabs 70, the slots 62 are machined into the face on the ring gasket's outer periphery. The number of slots 62 and retainer tabs 70 can depend on the size and weight of the ring gasket 60, although the slots 62 are preferably spread around the perimeter evenly. As an alternative, the ring gasket 60 may be formed with one or more integral retainer tabs 70 extending therefrom, although modifying an existing ring gasket 60 with slots 62 and separate tabs 70 is preferred.

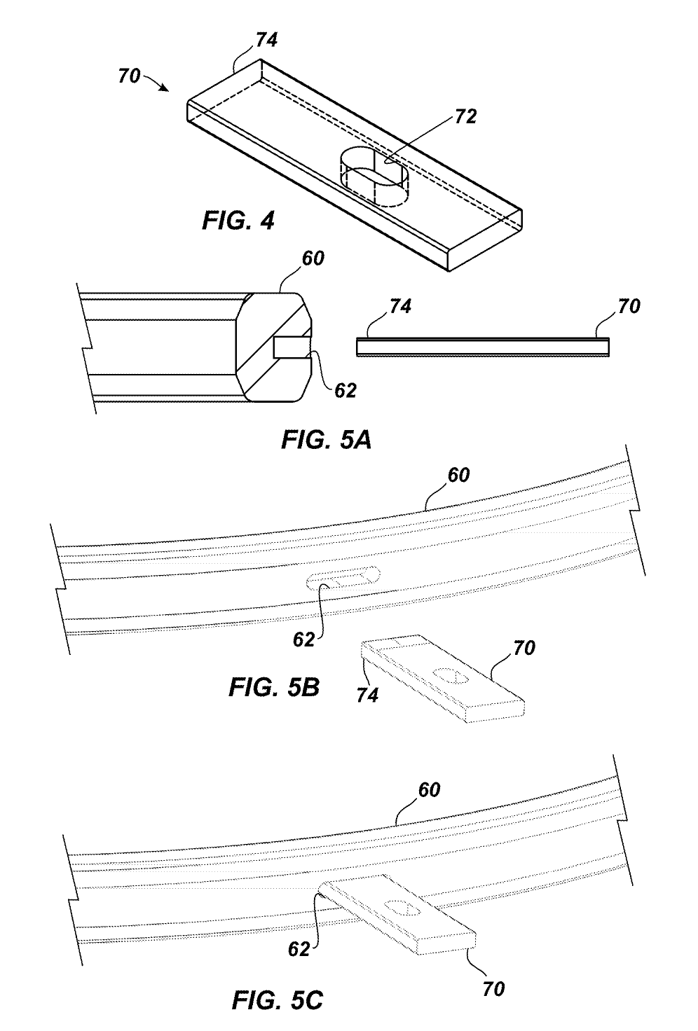

As shown in FIG. 5A, each slot 62 is defined partially in the outer periphery of the ring gasket 60 and need only extend to about the width of the retainer tab 70. As shown in FIG. 4, the retainer tab 70 can be a flat, thin plate, although other shapes could be used. The tab 70 has an opening 72 near its distal end that is elongated along the axis of the tab 70. In general, the retainer tabs 70 can be composed of metal, plastic, polymer, composite or other materials. Dimensions of the retainer tabs 70 depend on the sizes of the flange 40 and ring gasket 60 to be used. In most implementations, the retainer tabs 70 can be about ⅛ inch thick, ½ inch wide, and about 1 to 3 inches in length.

As shown in FIGS. 5A-5C, a proximal end 74 of the retainer tab 70 inserts into the slot 62 in the ring gasket 60. This is repeated around the ring gasket 60 so the ring gasket 60 can have several retainer tabs 70 extending radially outward from its external boundary or periphery. The retainer tab 70 has a positive interference fit to hold it in the slot 62 machined into the ring gasket 60. This interference fit can be provided by shrink or expansion fitting the proximal end 74 of the tab 70 in the slot 62. For example, the retainer tab 70 can be super-cooled before insertion into the ring gasket's slot 62. Once inserted in the slot 62, the retainer tab 70 warms to ambient temperature, and the end 74 of the tab 70 expands in the slot 62 to create the interference fit. Other techniques for affixing the tab 70 in the slot 62 could also be used, including wedging the tab 70 in the slot 62 with a friction fit, using a fastener, etc.

For its part, the flange 40 shown in FIG. 3 has its seal seat 42 around the central bore 46 for placement of the ring gasket 60. The flange 40 also has fastener openings 48 used for bolting to the opposing flange 30 as is known in the art. In general, the flange 40 can be an industry standard (ANSI, MSS, API, etc.) pipe flange.

Separate from the preparation of the retainer tabs 70 on the ring gasket 60, the placement pins 80 install in predrilled holes 44 in the face of the flange 40. Holes 44 for the placement pins 80 are pre-drilled around the outside of the seal seat 42. These holes 44 can be any suitable diameter to accommodate the placement pins 80. In general, the placement pins 80 can be a screw, a bolt, a pin, a rivet, a plug, or other fastener that holds the retainer tabs 70 to the flange's face. For example, as a pin, the placement pins 80 can be a spring pin composed of steel. However, the placement pins 80 could be composed of other materials, such as plastic, brass, etc.

Preferably, the placement pins 80 have a positive interference fit with the holes 44 drilled into the flange's face. Therefore, the ends of the pins 80 may screw or otherwise affix in the holes 44 so the pins 80 can be fit and held in the holes 44 before assembly. Either way, the exposed ends of the pins 80 preferably insert into the openings 72 in the retainer tabs 70 so the tabs 70 can be pushed onto the pins 80 without additional turning, screwing, or other assembly needed.

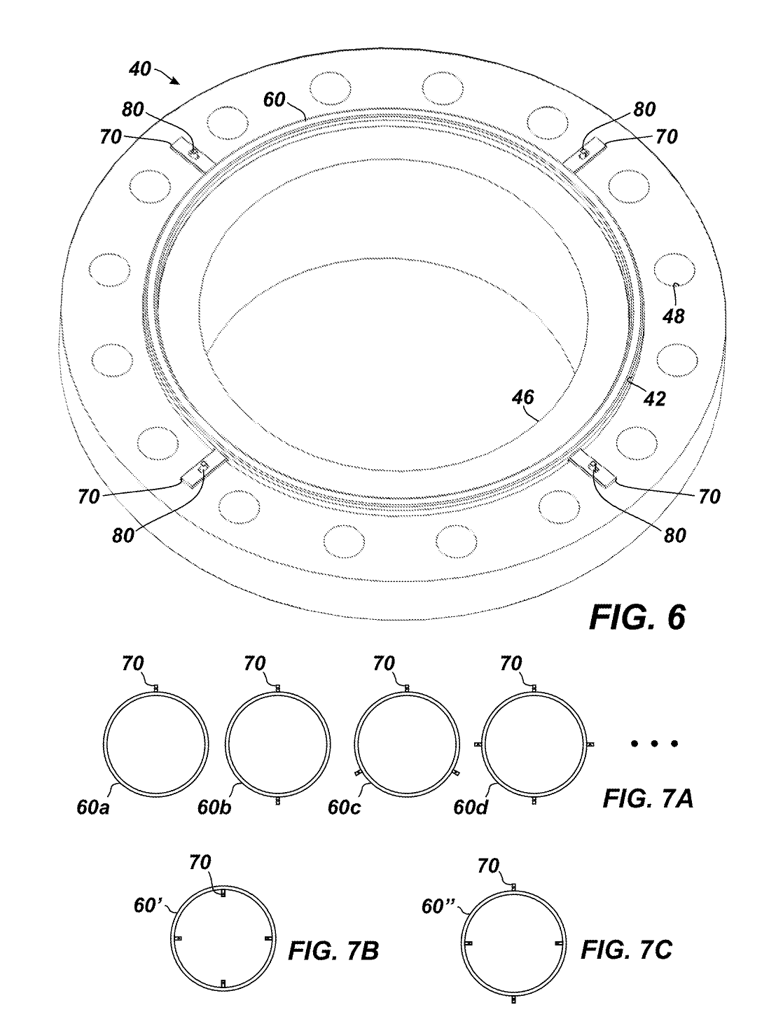

As shown in FIG. 6, the ring gasket 60 with fitted retainer tabs 70 positions in the seal seat 42 defined in the face of the flange 40 around the center bore 46. The retainer tabs 70 line up with the placement pins 80, and the tab's openings 72 fit onto the exposed pins 80 to hold the ring gasket 60 in place during assembly. The placement pins 80 positively connect the retainer tabs 70 and ring gasket 60 to the flange's face. To that end, the placement pins 80 preferably have an interference fit with the tab's openings 72 to hold the ring gasket 60 in place, even when the flange 40 is turned face down. For adjustment of the ring gasket's placement, the openings 72 on the retainer tabs 70 are preferably elongated along the longitudinal axis of the tab 70.

Although four retainer tabs 70 are shown in FIG. 6, more or less could be used. For example, FIG. 7A shows a series of ring gaskets 60a, 60b, having one or more retainer tabs 70. The number of retainer tabs 70 used can depend on the size of the ring gasket 60 and the orientation of the flange 40. In any event, the retainer tabs 70 are preferably disposed evenly or symmetrically around the ring gasket 60 so operators can place the ring gasket 60 regardless of its orientation.

Although the retainer tabs 70 are shown extending radially outward in FIGS. 2A, 5A-5C, 6 and 7A, for example, an alternate arrangement may have each of the tabs 70 extending radially inward from the gasket's internal boundary. As shown in FIG. 7B, for example, the ring gasket 60′ has retainer tabs 70 extending radially inward from the gasket's internal boundary. Still further, it is possible to have a mixed number of inward and outward extending tabs 70. In another arrangement shown in FIG. 7C, the ring gasket 60″ has inward and outward extending tabs 70. These and other arrangements are possible with the benefit of the present disclosure.

Because the tabs 70 temporarily hold the gasket, having the tabs 70 extend inward from the internal boundary of the gasket 60 can be suitable in most implementations. Of course, the positions for the pins 80 on the prepared flange 40 need to match the expected arrangement for the tabs 70 on the gasket 60. Therefore, pre-drilled holes 44 and placement pins 80 can be positioned inside the seat 42 on the flange 40 as needed.

While the ring gasket 60 sits within the seal seat 42 as shown in FIG. 6 keeping the ring gasket 60 from moving along the flange's face, the retainer tabs 70 and placement pins 80 keep the ring gasket 60 from moving away from or off of the flange's face. As noted above, the elongated openings 72 allow for some adjustment in the alignment and placement of the ring gasket 60 in the seal seat 42.

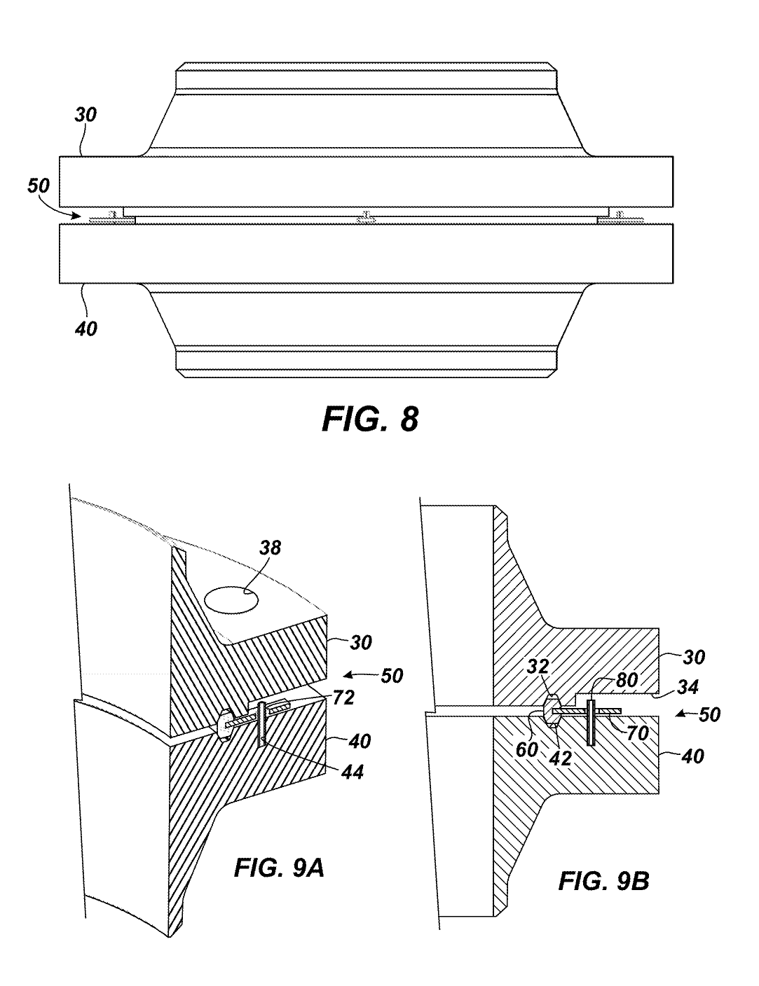

Finally as shown in FIG. 8, the other flange 30 is mated with the prepared flange 40 so the two flanges 30/40 can be bolted together to complete the coupling 50. FIGS. 9A-9B show cross-sections of the coupling 50 between the flanges 30/40. As noted above, the ring gasket 60 fits into the seal seat 42 in the prepared flange 40. The placement pin 80 in the pre-drilled hole 44 fits in the elongated opening 72 in the retainer tab 70 to hold the ring gasket 60 during assembly. The opposing flange 30 has a complementary seal seat 32 that also fits on the ring gasket 60 to complete the seal between the flanges 30/40.

Depending on space requirements, the opposing flange 30 can define a peripheral cutaway 34 where the bolt openings 38 are formed. This cutaway 34 can accommodate excess length of the placement pins 80. Of course, the other flange 40 can also have such a peripheral cutaway (not shown) either alone or in combination with the cutaway 34 in opposing flange 30. Still, both flanges 30/40 may not have such a cutaway depending on the particular implementation.

In the present implementation, the pins 80 pre-install in the pre-drilled holes 44, and the tabs 70 have the elongated openings 72 to allow for adjustment on the pins 80. As an alternative, a reverse arrangement can be used. The pre-drilled holes 44 in the flange 40 may be elongated, and the pins 80 may be affixed or integrated as part of the retainer tabs 70. For this arrangement, operators positioning the ring gasket 60 on the prepared flange 40 can position the pins 80 on the tabs 70 into the pre-drilled holes when placing the ring gasket 60 in the seat 42.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A gasket retention system for a flange coupling, comprising:
a ring gasket disposing in seal seats on opposing flanges;
at least one retainer tab disposed on the ring gasket and defining a transverse opening therethrough; and
at least one fastener affixing in at least one hole defined in a face of one of the opposing flanges and affixing into the transverse opening of the at least one retainer tab.

2. The system of claim 1, wherein the ring gasket defines at least one slot, and wherein the at least one fastener affixes in the at least one slot.

3. The system of claim 2, wherein the at least one retainer tab affixes with an interference fit in the at least one slot of the ring gasket.

4. The system of claim 2, wherein the ring gasket defines the at least one slot in an inner periphery, and wherein the retainer tab extends radially inward on the ring gasket.

5. The system of claim 2, wherein the ring gasket defines the at least one slot in an outer periphery, and wherein the retainer tab extends radially outward on the ring gasket.

6. The system of claim 1, wherein the at least one retainer tab is composed of metal, plastic, polymer, or composite material.

7. The system of claim 1, wherein the transverse opening defined through the at least one retainer tab is elongated.

8. The system of claim 1, wherein the at least one fastener comprises a screw, a bolt, a pin, a rivet, or a plug.

9. The system of claim 1, wherein the at least one fastener affixes with an interference fit in the transverse opening in the at least one retainer tab.

10. The system of claim 1, wherein the ring gasket has a plurality of the at least one retainer tabs disposed thereabout, the retainer tabs affixing to a plurality of the at least one fasteners.

11. A flange coupling, comprising:
a first flange defining a first seal seat in a first face and defining at least one hole in the first face;
at least one fastener affixing in the at least one hole defined in the first face; and
a ring gasket disposing in the first seal seat, the ring gasket having at least one retainer tab disposed thereon, the at least one retainer tab defining a transverse opening therethrough affixing onto the at least one fastener.

12. The flange coupling of claim 11, wherein the ring gasket defines at least one slot, and wherein the at least one retainer tab affixes in the at least one slot and extends from the ring gasket.

13. The flange coupling of claim 12, wherein the at least one retainer tab affixes with an interference fit in the at least one slot of the ring gasket.

14. The flange coupling of claim 12, wherein the ring gasket defines the at least one slot in an inner periphery, and wherein the retainer tab extends radially inward on the ring gasket.

15. The flange coupling of claim 12, wherein the ring gasket defines the at least one slot in an outer periphery, and wherein the retainer tab extends radially outward on the ring gasket.

16. The flange coupling of claim 11, wherein the at least one retainer tab is composed of metal, plastic, polymer, or composite material.

17. The flange coupling of claim 11, wherein the transverse opening through the at least one retainer tab is elongated.

18. The flange coupling of claim 11, wherein the fastener comprises a screw, a bolt, a pin, a rivet, or a plug.

19. The flange coupling of claim 11, wherein the at least one fastener affixes with an interference fit in the transverse opening in the at least one retainer tab.

20. The flange coupling of claim 11, further comprising a second flange mating with the first flange, the second flange defining a second seal seat in a second face, the ring gasket disposing in the second seal seat.

21. The flange coupling of claim 20, wherein the second flange comprises a cutaway in a periphery of the second face.

22. The flange coupling of claim 11, wherein the ring gasket has a plurality of the at least one retainer tabs disposed about the outer periphery, the retainer tabs affixing to a plurality of the at least one fasteners.

23. A method of retaining a ring gasket between flanges, comprising:
installing at least one fastener in a first face of a first flange;
installing a ring gasket in a first seal seat of the first flange;
affixing at least one retainer tab on the ring gasket onto the at least one fastener;
mating a second flange to the first flange.

24. The method of claim 23, further comprising affixing the at least one retainer tab on the ring gasket

25. The method of claim 24, wherein affixing the at least one retainer tab on the ring gasket comprises interference fitting an end of the at least one retainer tab in the at least one slot.

26. The method of claim 23, wherein the at least one retainer tab is composed of metal, plastic, polymer, or composite material.

27. The method of claim 23, wherein affixing the at least one retainer tab onto the at least one fastener comprises fitting the at least one fastener in a transverse opening defined through the at least one retainer tab

28. The method of claim 27, wherein the transverse opening is elongated.

29. The method of claim 27, wherein fitting the at least one fastener in the transverse opening comprises fitting the at least one fastener with an interference fit in the transverse opening.

30. The method of claim 23, wherein the fastener comprises a screw, a bolt, a pin, a rivet, or a plug.

31. The method of claim 23, wherein installing the at least one fastener in the first face comprises drilling at least one hole in the first face and installing the at least one fastener therein.

32. The method of claim 23, wherein the second flange comprises a cutaway in a periphery of the second face.

33. The method of claim 23, wherein mating the second flange to the first flange comprises installing the ring gasket in a second seal seat of the second flange.
